(19) United States
(12) Patent Application Publication
(10) Pub. No.: US 2009/0089206 A1
(43) Pub. Date: Apr. 2, 2009

(54) Methods and systems for on-line loan procurement

(76) Inventor: Martin Lukac, San Diego, CA (US)

Correspondence Address: Martin Lukac, 1131 La Casa Drive, San Diego, CA, 92078, US

(21) Appl. No.: 11/906,232

(22) Filed: Oct. 1, 2007

(51) Int. Cl. G06F 17/40; G06F 19/00; G06Q 40/00

(52) U.S. Cl. 705/38

(57) ABSTRACT

The present invention relates to methods and systems for on-line loan procurement. More particularly, the invention relates to methods and systems for enabling consumers to apply for a loan or other financing arrangements (including credit cards), lenders to submit bids for such a loan or financing arrangement, and consummating a loan or financing transaction. In one embodiment of the invention, methods for consummating a loan transaction are provided, which comprise providing a website in which a borrower may submit an application for a loan to a plurality of lenders, whereby application purposely excludes information that may be used to identify or contact the borrower. According to such methods, a server is also provided which is capable of (i) receiving the borrower's loan application and transmitting information contained in the application to a plurality of lenders, (ii) receiving loan bids from the plurality of lenders, and (iii) transmitting and displaying the loan bids to the borrower.

### FIELD OF THE INVENTION

The field of the present invention relates to methods and systems for on-line loan procurement. More particularly, the invention relates to methods and systems for enabling consumers to apply for a loan or other financing arrangements, lenders to submit bids for such a loan or financing arrangement, and consummating a loan or financing transaction.

### BACKGROUND

The field of on-line loan procurement has grown rapidly over the past several years. Indeed, both lenders and borrowers alike have recognized and harnessed the global reach and efficiencies that may be gained through internet-mediated loan application and procurement. In fact, a group of websites have emerged, such as www.lendingtree.com, which is beneficial to prospective borrowers, insofar as such websites purport to cause lenders to compete with each other for loans, thereby providing borrowers with truly competitive rates.

While such websites have provided prospective borrowers with the ability to solicit bids for loans from a plurality of lenders, these websites have suffered certain drawbacks. For example, such websites require that prospective borrowers enter personally identifiable information in loan applications, which are then submitted to a plurality of lenders. This information often discloses not only the identity of the prospective borrower, but also his or her contact information. Such disclosure often leads to a whole host of problems.

First, it enables lenders to place unwanted and unsolicited calls (or other communications) to prospective borrowers. In addition, in the event that a prospective borrower also submits his or her social security number, such disclosure may be used by lenders to perform credit checks of such borrowers, which itself can lower a borrower's credit score. These problems resulting from the disclosure of such personally identifiable information will often deter prospective borrowers from submitting requests for loans using these on-line systems.

In view of the foregoing, there is a continuing demand for methods and systems that allow borrowers to submit a request for bids for a loan to a plurality of lenders, while not prematurely disclosing personally identifiable information to such lenders.

### SUMMARY OF THE INVENTION

According to a first preferred embodiment of the invention, methods for consummating a loan transaction are provided, which comprise providing a website in which a borrower may submit an application for a loan to a plurality of lenders, whereby the application is purposely designed to exclude information that may be used to identify or contact the borrower. According to such methods, a server is also provided which is capable of (i) receiving the borrower's loan application and transmitting information contained in the application to a plurality of lenders, (ii) receiving loan bids from the plurality of lenders, and (iii) transmitting and displaying the loan bids to the borrower.

According to a second preferred embodiment of the invention, methods for awarding a credit card to a customer are provided. Such methods generally comprise providing a website in which a customer may submit an application for a credit card to a plurality of card issuers, wherein the application purposely excludes contact and identity information of the customer. Such methods further comprise providing a server that is capable of (i) receiving the customer's loan application and transmitting information contained therein to a plurality of card issuers, (ii) receiving bids from the plurality of card issuers, and (iii) transmitting and displaying the bids to the customer.

According to a third embodiment of the present invention, further methods for consummating a loan transaction are provided. In such embodiments, the methods generally comprise providing a website in which a borrower may submit an application for a loan to a plurality of lenders. Unlike the other embodiments described above, the application requires the prospective borrower to submit his or her contact and identity information. The methods further comprise providing a server capable of receiving the application and transmitting information contained in the application to a plurality of lenders. The information that is transmitted to the plurality of lenders, however, does not include the contact and identity information of the borrower (or, alternatively, such information is redacted and not visible to the lenders).

According to a fourth preferred embodiment of the invention, systems are provided that may be used to consummate loan transactions, including the issuance of credit cards to customers. The systems generally comprise a computer terminal that is capable of displaying a website in which a borrower may submit an application for a loan to a plurality of lenders, whereby the loan application purposely excludes contact and identity information of the borrower. The systems of the present invention further comprise a server capable of (i) receiving the loan application and transmitting information contained therein to a plurality of lenders, (ii) receiving loan bids from the plurality of lenders, and (iii) transmitting and displaying the loan bids to the borrower. The systems of the present invention may further comprise one or more databases, which stores and provides information related to a plurality of lenders and/or prospective borrowers. In such embodiments, the database is capable of communicating with the server, which makes certain information housed within such database accessible and viewable within the above-mentioned website.

The above-mentioned and additional features of the present invention are further illustrated in the Detailed Description contained herein.

### BRIEF DESCRIPTION OF THE FIGURES

FIG. 1 is a flow diagram that outlines certain embodiments of the present invention, which relate to methods for mortgage loan procurement.

FIG. 2 is a flow diagram that outlines additional embodiments of the present invention, which relate to methods for mortgage loan procurement.

FIG. 3 is a flow diagram that outlines further embodiments of the present invention, which relate to methods for mortgage loan procurement.

FIG. 4 is a flow diagram that outlines yet further embodiments of the present invention, which relate to methods for mortgage loan procurement.

FIG. 5 is a flow diagram that outlines certain embodiments of the present invention, which relate to methods for automobile loan procurement.

FIG. 6 is a flow diagram that outlines additional embodiments of the present invention, which relate to methods for automobile loan procurement.

FIG. 7 is a flow diagram that outlines further embodiments of the present invention, which relate to methods for automobile loan procurement.

FIG. 8 is a flow diagram that outlines yet further embodiments of the present invention, which relate to methods for automobile loan procurement.

FIG. 9 is a flow diagram that outlines still further embodiments of the present invention, which relate to methods for general loan procurement.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used, and made without departing from the scope and spirit of the invention.

The present invention generally relates to certain methods and systems for requesting bids for a loan or credit, for providing quotes for a loan or credit, and for consummating loan transactions (and transferring credit) between borrowers and lenders. More particularly, in certain embodiments, the invention comprises an on-line system, which may be implemented within a website, which allows prospective borrowers to submit a request for one or more quotes (or bids) for a loan. The request is then provided to a plurality of potential lenders in an on-line environment, whereby one or more lenders may respond by submitting a quoted loan rate (and related loan terms), as described further below, which may be accessed and viewed by the prospective borrower.

The loan application submitted by prospective borrowers preferably includes certain detailed information about the type and terms of the loan requested, but specifically and purposely excludes the prospective borrower's name, telephone number, social security number, or other contact information (whereby such contact information will only be made available to the lender that is selected by the borrower). The methods and systems of the present invention allow prospective borrowers to quickly solicit competitive bids for loans from a variety of lenders, while avoiding the burden of having numerous prospective lenders call or otherwise contact the prospective borrower. The on-line forms that are employed in the methods, systems, and websites described herein are specially tailored to provide lenders with sufficient information to provide an informed quote for a loan—despite not having access to the prospective borrower's identity and contact information.

According to a first preferred embodiment of the invention, methods for consummating a loan transaction are provided, which comprise providing a website in which a borrower may submit an application for a loan to a plurality of lenders, whereby the application is purposely designed to exclude information that may be used to identify or contact the borrower. For example, the application preferably does not require a prospective borrower to provide his or her name, residential or mailing address, phone number, e-mail address, or social security number. According to such methods, a server is also provided which is capable of (i) receiving the borrower's loan application and transmitting information contained in the application to a plurality of lenders, (ii) receiving loan bids from the plurality of lenders, and (iii) transmitting and displaying the loan bids to the borrower.

The invention provides that the loan bids are preferably transmitted and displayed to the borrower within the website. According to such embodiments, the borrower may access the website described herein and, through the use of an on-line form, submit a username and password to validate and authenticate his or her identity. The username and/or password are submitted to the server, which determines whether such username and password is valid and authentic. If the username and password is valid and authentic, the borrower is allowed to access a portion of the website in which the loan bids that were submitted by the plurality of lenders are shown. Preferably, the loan bids that are shown further list the lender's name and contact information, such that the borrower may optionally contact a particular lender to discuss the terms of its bid (and/or to ask questions of the lender). As described further below, the webpage that lists the loan bids may further include hyperlinks to other pages that are dedicated to each lender that submitted a bid—in which further information may be shown regarding the applicable lender.

The invention provides that the server is further capable of receiving an instruction from the borrower, such as through an on-line form housed within the website, to accept and select a loan bid from a particular lender. Preferably, the website will include a means for instructing the server that the borrower wishes to accept the terms and bid offered by a particular lender, whereby the applicable lender is further notified of its selection by the borrower (such as, for example, by automatically sending an electronic mail message to the applicable lender apprising it of the borrower's election). In the event that a borrower selects a particular lender, the invention provides that, at that time, the lender may be provided with the borrower's personal information, including his or her identity and/or contact information, in order to facilitate the closing of the loan.

The invention provides that the information contained in a prospective borrower's loan application, which is provided to the server through the website, may be transmitted to a limited number of lenders, such as 1, 2, 3, 4, 5, 6, 7, 8, or other limited numbers of lenders. The invention provides that, in certain preferred embodiments, the information contained in a prospective borrower's loan application is transmitted to a group of six lenders. The invention provides that by submitting the information contained in a prospective borrower's loan application to six lenders, a sufficient number of lenders will receive the information to create a desirable and meaningful number of bids for the borrower to consider. That is, if such information were transmitted to thousands of lenders, the borrower may be disinclined to review the extreme number of bids that would likely be returned. Similarly, if the information is transmitted to only two lenders, the borrower may not receive a desirable quote, insofar as there would be little competition for a competitive rate among just two lenders.

According to such embodiments, the invention provides that the limited number of lenders may be randomly selected from a group of lenders listed within a database. Alternatively, the invention provides that a prospective borrower may specify the lenders to which he or she would like to submit a loan application. Still further, the invention provides that the lenders to which the loan application is submitted may be based on other criteria, such as the geographic location of the lender, minimum and/or maximum loan amounts set by the lender, or other criteria. Preferably, in such embodiments of the invention, such criteria will be published within the website described herein.

In certain embodiments, if the borrower does not select and accept the bid offered by a limited number of lenders, the information contained in the loan application may be re-transmitted to a plurality of additional lenders. The number of such additional lenders may be the same number of lenders to which such information was originally transmitted or, alternatively, the number of such additional lenders may be different than the number of lenders to which such information was originally transmitted (e.g., the information contained in the loan application may be transmitted to more lenders in attempt to recruit a bid that the borrower is willing to accept).

According to certain embodiments, the invention provides that lenders may pay a recurring membership fee to the business that owns and operates the website described herein. Such a membership fee would constitute remuneration for the right to receive loan applications from prospective borrowers and, potentially, be awarded a loan. Alternatively, or in addition to such membership fees, the business that owns and operates the website may be paid a commission or royalty that represents a percentage (or some fraction of) any loan amounts that are awarded and consummated through the website described herein.

Still further, in certain embodiments, the lenders may be charged a small fee each time that a prospective borrower accesses information regarding a particular lender and/or its quote. For example, after a prospective borrower submits a loan application and is provided with a series of quotes submitted by a plurality of lenders, the webpage in which such quotes are shown may include hyperlinks to additional pages which contain additional information related to a particular lender. In such embodiments, the business that owns and operates the website described herein may charge such lender a fee each time a prospective borrower “clicks” on such hyperlink and accesses the lender-specific webpage.

According to a second preferred embodiment of the invention, methods for awarding a credit card to a customer are provided. The invention provides that such methods are essentially carried out in the same (or similar) way in which the methods of consummating a loan transaction are performed, as described above. For example, such methods generally comprise providing a website in which a customer may submit an application for a credit card to a plurality of card issuers, wherein the application purposely excludes contact and identity information of the customer. Such methods further comprise providing a server that is capable of (i) receiving the customer's loan application and transmitting information contained therein to a plurality of card issuers, (ii) receiving bids from the plurality of card issuers, and (iii) transmitting and displaying the bids to the customer.

According to a third embodiment of the present invention, further methods for consummating a loan transaction are provided. In such embodiments, the methods generally comprise providing a website in which a borrower may submit an application for a loan to a plurality of lenders. Unlike the other embodiments described above, the application requires the prospective borrower to submit his or her contact and identity information. The methods further comprise providing a server capable of receiving the application and transmitting information contained in the application to a plurality of lenders. The information that is transmitted to the plurality of lenders, however, does not include the contact and identity information of the borrower (or, alternatively, such information is redacted and not visible to the lenders).

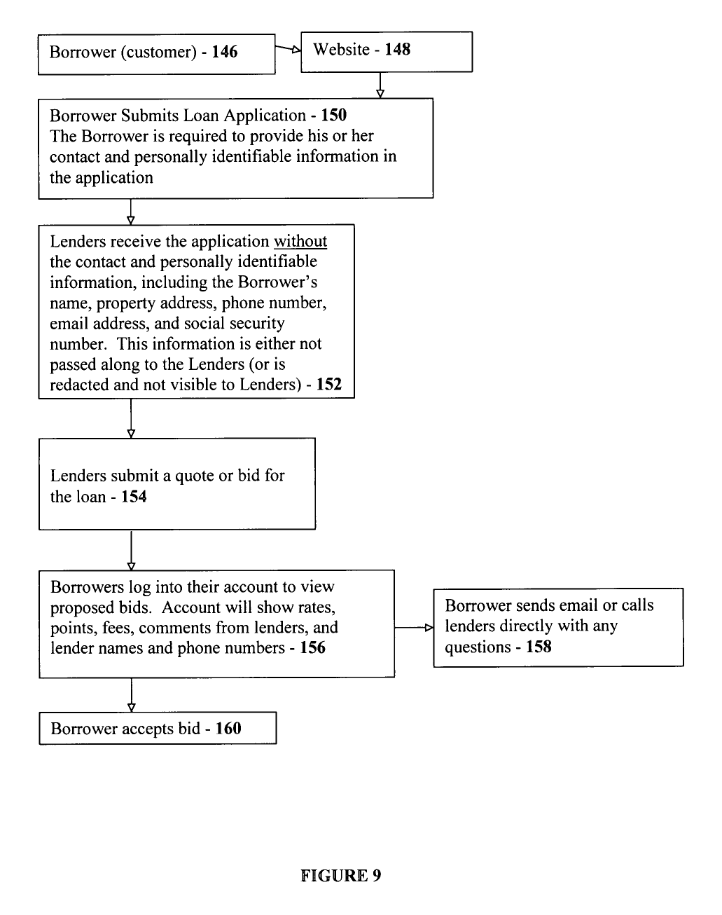

The server is further capable of receiving loan bids from the plurality of lenders and transmitting and displaying the loan bids to the borrower. In the event that the borrower selects a loan bid offered by a particular lender, at that time, the server transmits the borrower's contact and identity information to the lender that is selected by the borrower. The remaining portions of such methods of the invention are similar to those described above, relative to the other embodiments of the invention, except that the loan bids submitted by the lenders may be transmitted and displayed to the borrower within the website or provided to the borrower via electronic mail (insofar as the prospective borrower will have previously provided the server with his or her e-mail address through the submission of the loan application). The foregoing embodiment is further summarized and briefly outlined in FIG. 9.

According to a fourth preferred embodiment of the invention, systems are provided that may be used to consummate loan transactions, as well as issue credit cards to customers. The systems generally comprise a computer terminal that is capable of displaying a website in which a borrower may submit an application for a loan to a plurality of lenders, whereby the loan application purposely (1) excludes contact and identity information of the borrower or (2) includes such contact and identity information of the borrower (whereby such contact and identity information is subsequently removed or redacted before it is transferred to a plurality of lenders as described herein). As used herein, the term “computer terminal” refers to, for example, a personal computer, a smart phone, a cell phone, a PDA, or any other device having a microprocessor (or that is otherwise capable of accessing a website).

The systems of the present invention further comprise a server capable of (i) receiving the loan application from a prospective borrower and transmitting information contained therein to a plurality of lenders, (ii) receiving loan bids from the plurality of lenders, and (iii) transmitting and displaying the loan bids to the borrower. The systems of the present invention may further comprise one or more databases, which stores and provides information related to a plurality of lenders and prospective borrowers. In such embodiments, the database is capable of communicating with the server, whereby, for example, the server is capable of receiving information from borrowers and lenders through the website described herein and, based on such information, performing a function based on information stored within the database.

For example, in certain embodiments of the present invention, a prospective borrower may designate the lenders to which his or her loan application will be submitted. In such embodiments, the website may contain a searchable field that allows prospective borrowers to search for a particular lender, a lender in a particular geographical region, or a lender based on other criteria (such as, e.g., minimum or maximum loan amounts). The criteria that the borrower uses to identify such lenders may be stored within a database in fluid communication with the server, whereby upon the server receiving the lender-specific criteria from the borrower (through the website described herein), the server is able to query the database and convey appropriate search results, for example, to the borrower within the website. The invention provides that the database may be housed within the same, or different, server in which the website described herein is hosted. In addition, it will be appreciated that while the description of the systems have been in the context of loan transactions, the systems are further useful in the methods of issuing credit cards described herein.

The subject invention may be used in a variety of loan-type transactions, including real estate loans, automobile loans, credit card rates, and others. An important aspect of the present invention is (a) the ability for borrowers/customers to submit a request for a loan to a plurality of lenders, (b) the ability of lenders to, based on the information provided by prospective borrowers/customers, submit a quote for the requested loan, and (c) the ability to carry out the preceding two steps without the need of the prospective borrower/customer to provide the lenders with his or her identity or contact information.

The invention provides that by employing specially tailored on-line forms within the website described herein, prospective borrowers will submit a sufficient amount of information to enable lenders to provide a meaningful quote for the requested loan. For example, in the case of a system that is designed to facilitate mortgage lending transactions according to the present invention, the on-line forms within the website may require the prospective borrower to identify: (1) the location of the property, (2) the amount of the borrower's anticipated down-payment (initial installment towards the loan), (3) the type of loan requested (e.g., 30-year fixed rate, 15-year fixed rate, adjustable rate mortgage (ARM), etc.), (4) the borrower's age and current income, (5) the borrower's current debt load, and (6) the borrower's self-assessment of his or her credit risk (e.g., whether the borrower believes his or her credit score to be very good, good, average, below average, or well below average). Similarly, for example, in the case of a system that is designed to facilitate automobile lending transactions according to the present invention, the on-line forms within the website may require the prospective borrower to identify: (1) the type of car that will be purchased with the loaned money (e.g., new or used automobile; the model and make of the automobile; the year of the automobile; and other automobile-specific information), (2) the amount of the borrower's anticipated down-payment (initial installment towards the loan), (3) the type of loan requested (e.g., 1, 2, 3, 4, 5, or 6 year term), (4) the borrower's age and current income, (5) the borrower's current debt load, and (6) the borrower's self-assessment of his or her credit risk.

The invention provides that the loan quotes submitted by lenders in response to a prospective borrower's loan application may include contingencies. For example, the loan quotes submitted by lenders may be contingent upon, and subject to, the accuracy of the information contained in the prospective borrower's loan application. In such embodiments, the loan quotes submitted by lenders may represent binding contractual offers that, if accepted by the prospective borrower, would form a legally binding commitment. If such loan quotes are contingent upon the accuracy of all information contained in the prospective borrower's loan application, and if certain information contained in a particular borrower's application is false, the lender that is selected by the borrower would have the right (but not the obligation) to withdraw the loan quote and terminate the loan transaction.

The invention provides that withholding a prospective borrower's personal identifiable and contact information from lenders will serve to significantly reduce unwanted communications to, and solicitations of, prospective borrowers from such lenders. In addition, such design will mitigate the risk that lenders will unnecessarily and prematurely perform credit checks on prospective borrowers, which could otherwise damage a prospective borrower's credit score. Still further, by withholding a prospective borrower's personal identifiable and contact information from lenders (unless and until the borrower accepts an offer from a particular lender), prospective borrowers will be more inclined to utilize the methods and systems described herein.

The following examples are provided to further illustrate the methods and systems of the present invention. These examples are illustrative only and are not intended to limit the scope of the invention in any way.

### EXAMPLES

### Example 1

### Mortgage Loan Procurement

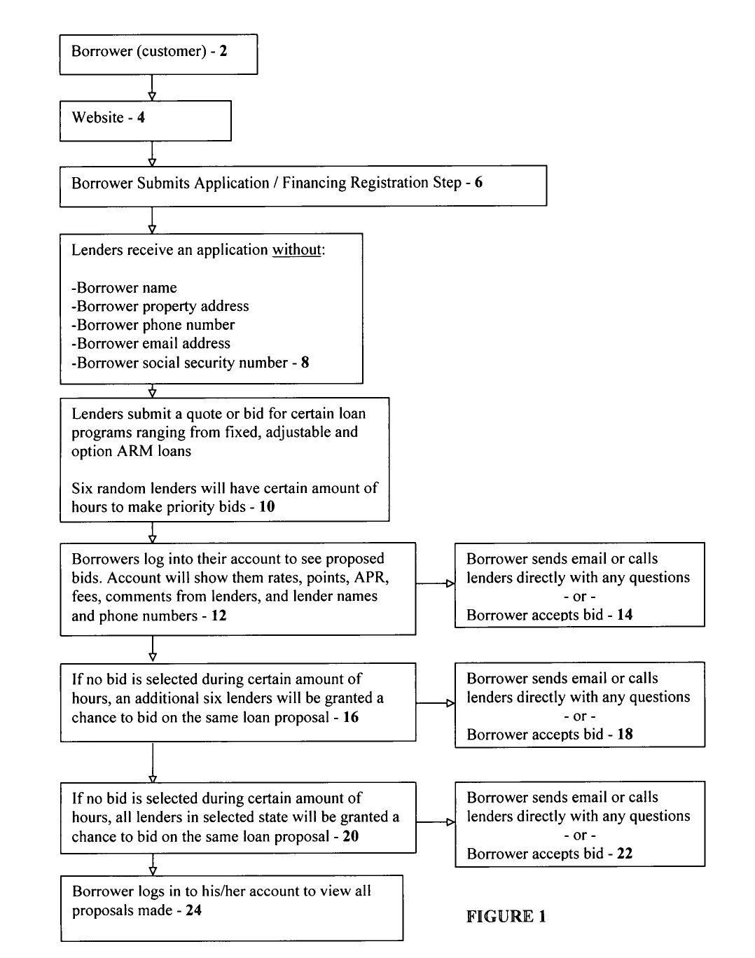

Referring to FIG. 1, a diagram is shown that briefly outlines certain exemplary methods of the present invention, which may be used in mortgage loan procurement. Specifically, a prospective borrower 2 accesses a website 4, which contains an on-line form into which the borrower 2 may enter certain information. For example, the borrower 2 may be required to enter (1) the location of the property that the borrower 2 will purchase with the loan, (2) the amount of the borrower's anticipated down-payment (initial installment towards the loan), (3) the type of loan requested (e.g., 30-year fixed rate, 15-year fixed rate, adjustable rate mortgage (ARM), etc.), (4) the borrower's age and current income, (5) the borrower's current debt load, and (6) the borrower's self-assessment of his or her credit risk (e.g., whether the borrower believes his or her credit score to be very good, good, average, below average, or well below average). Importantly, the on-line form excludes 8 the borrower's name, personal address, phone number, e-mail address, and social security number.

The information entered by the borrower 2 into the on-line form is submitted to a server, which then transmits such information to a plurality of randomly selected lenders, such as six different lenders. The server randomly selects the six different lenders from a list of lenders stored within a database. Upon receiving the borrower's loan application, the lenders are allowed to submit a quote (or bid) 10 for certain loan programs, such as fixed loans, ARMs, and option ARM loans. The quote (or bid) is submitted by each lender preferably through an on-line form, which may be accessed by the plurality of lenders within the website described herein. The on-line form through which the lenders may submit a quote for a loan may be accessed only with a unique username and password assigned to each lender or, alternatively, the quote that is submitted through the form may be accompanied by such a username and password (such that the quote will only be presented to the prospective borrower if, and only if, the lender's username and password is validated by the server).

Still referring to FIG. 1, the prospective borrower 2 may then access his or her personal account page within the website by, for example, providing the server (e.g., through an on-line form) with his or her unique username and password. Once the prospective borrower's 2 username and password is validated (confirmed) by the server, the website displays a page in which each lender's quote is shown 12, wherein the quote may also contain information concerning the term, conditions, and contingencies for such quote. The page may also show certain information related to each lender, such as each lender's contact information. At this point, if the prospective borrower 2 has questions regarding a particular quote, the borrower 2 may contact the applicable lender 14. In addition, at this point, the borrower 2 may accept a particular quote from a lender 14. The webpage in which the quotes are displayed will preferably include a button (or other website-mediated form element) that may be selected by the borrower 2 in order to instruct the server that the borrower wishes to accept the quote offered by a particular lender.

If the borrower 2 elects not to accept any quote from any lender, such non-election may be communicated to the server by the borrower 2 through the website (or, alternatively, the server may be programmed to automatically non-select the provided quotes if a certain amount of time elapses without the borrower 2 making a selection). If the borrower 2 elects not to accept any quote from any lender, the server may randomly select another limited group of lenders to which the borrower's 2 loan application will be submitted 16. Referring to FIG. 1, the transmission of the borrower's 2 loan application to another group of lenders creates another round of quote submission by the lenders 16 and an opportunity for the borrower 2 to select a quote or ask questions of the lenders 18. In certain embodiments, if the borrower 2 does not select a particular lender during a first or second round of quotes, the borrower's 2 loan application may subsequently be transmitted to a larger group of lenders, such as all lenders that are located within a particular state 20.

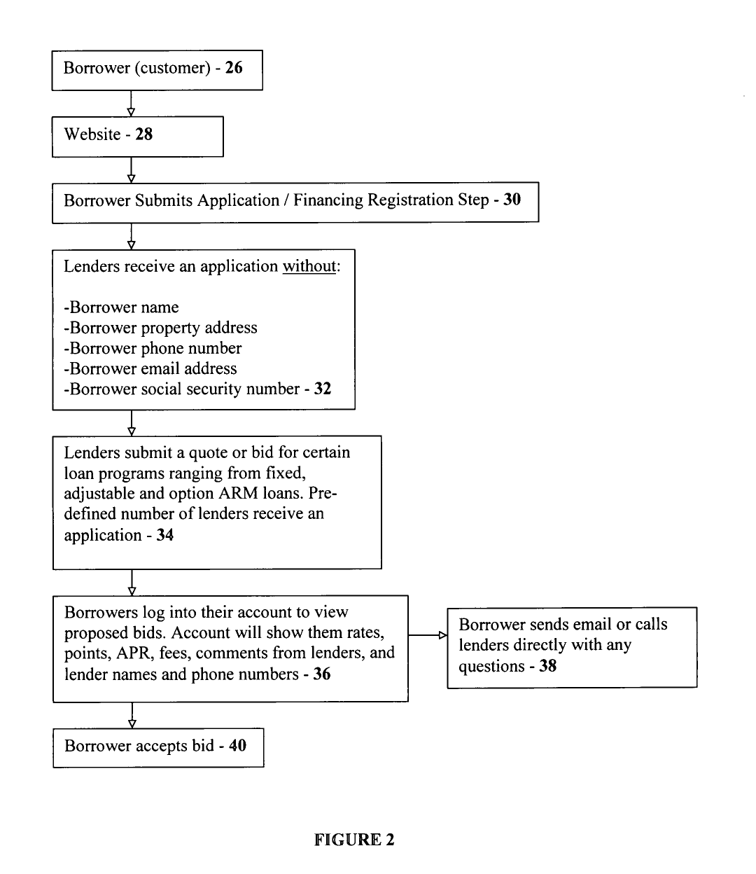

Referring to FIG. 2, the methods of this example may be tailored such that only a single round of quotes are submitted by lenders and considered by a prospective borrower. As shown in FIG. 2, for example, upon submitting a quote 34 in response to a borrower's 26 loan application, the borrower 26 is granted the ability to review the quotes 36, ask questions 38, and, optionally, select a quote 40. However, if the borrower 26 does not select a particular bid (or quote) 40, the borrower 26 must re-submit a new loan application in order to receive an additional set of bids (or quotes). Still further, according the methods of FIG. 2, the borrower's 26 loan application may be submitted to a pre-defined number of lenders, whereby the number of lenders to which the application is delivered may be managed by the website operator or specified by the borrower 26.

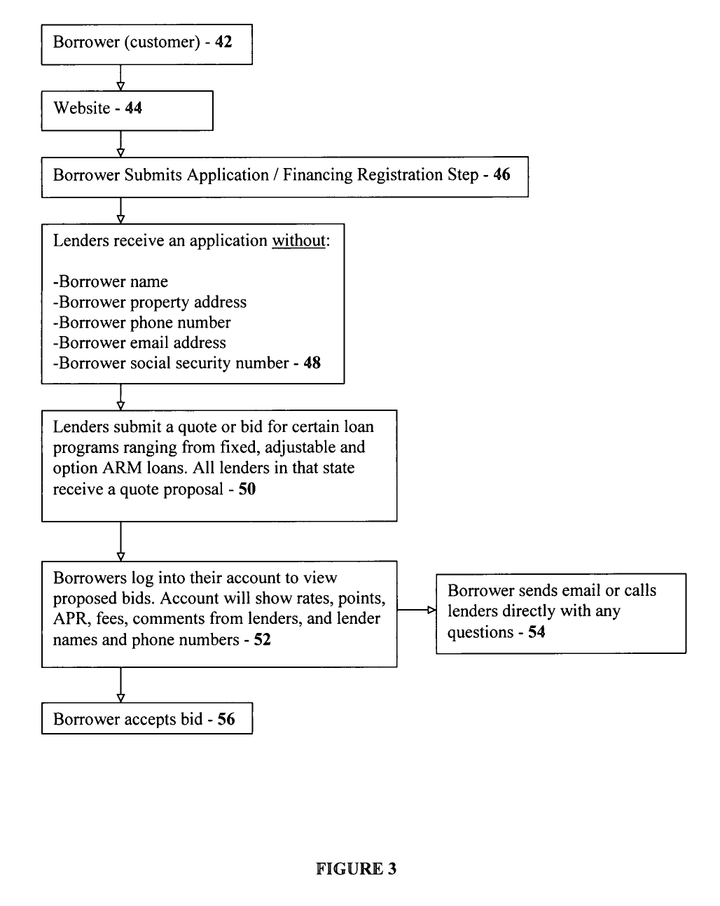

Alternatively, referring to FIG. 3, in certain embodiments of the invention, the borrower's 42 loan application may be submitted to all lenders in a particular geographical area, such as a state. More particularly, in certain embodiments of the invention, the borrower's 42 loan application may be submitted to all lenders that have registered with the website (and have provided the necessary information to the website server using, e.g., an on-line form within the website), which are located in a particular geographical area, such as a state.

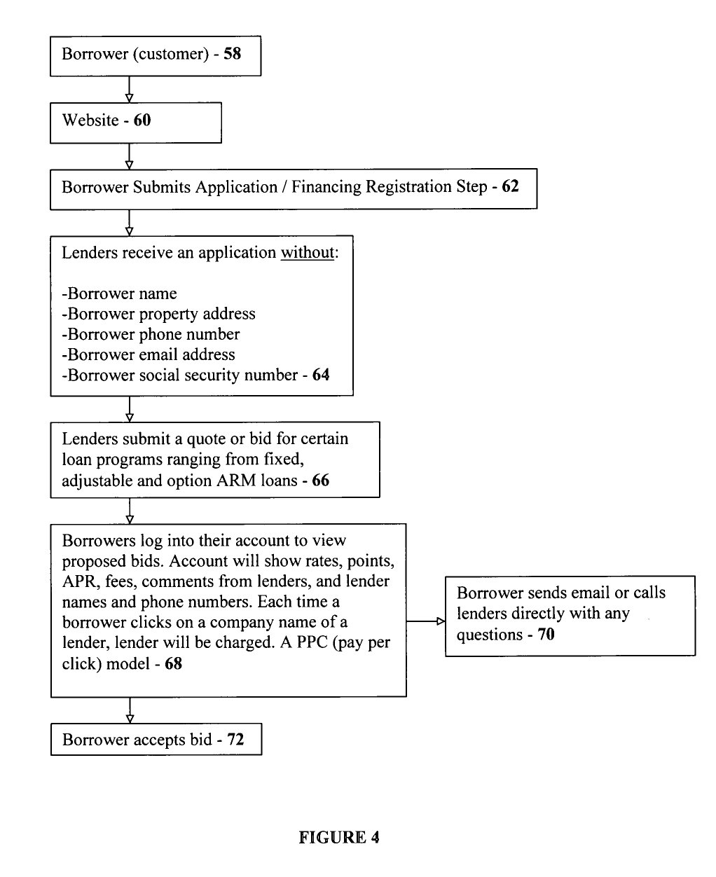

Referring now to FIG. 4, according to additional embodiments of this example, after the borrower 58 submits a loan application through the website 60, and is transmitted to a plurality of lenders, the lenders may submit a quote for the requested loan 66. After the quotes are submitted, the borrower 58 may access the quotes 68, as described herein, in a dedicated webpage. The dedicated webpage, containing such quotes 68, will further include hyperlinks to additional pages which contain additional information related to each particular lender. In such embodiments, the business that owns and operates the website described herein may charge such lender a fee each time a prospective borrower “clicks” on such hyperlink and accesses the lender-specific webpage 68. As with the other embodiments of this example, the borrower 58 may ask questions of a particular lender 70 and/or accept a particular bid (quote) from a lender 72.

### Example 2

### Automobile Loan Procurement

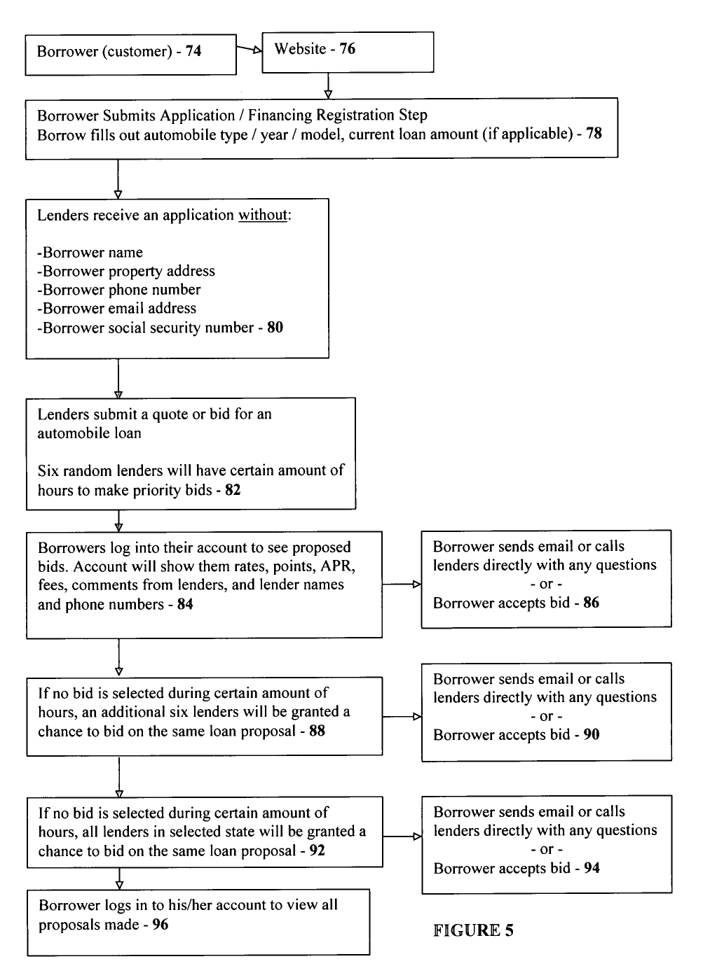

Referring to FIG. 5, a diagram is shown that briefly outlines certain exemplary methods of the present invention, which may be used in automobile loan procurement. Specifically, a prospective borrower 74 accesses a website 76, which contains an on-line form into which the borrower 74 may enter certain information. For example, the borrower 74 may be required to enter (1) the type of car that will be purchased with the loaned money (e.g., new or used automobile; the model and make of the automobile; the year of the automobile; and other automobile-specific information), (2) the amount of the borrower's anticipated down-payment (initial installment towards the loan), (3) the type of loan requested (e.g., 1, 2, 3, 4, 5, or 6 year term), (4) the borrower's age and current income, (5) the borrower's current debt load, and (6) the borrower's self-assessment of his or her credit risk. Importantly, the on-line form excludes 80 the borrower's name, personal address, phone number, e-mail address, and social security number.

The information entered by the borrower 74 into the on-line form is submitted to a server, which then transmits such information to a plurality of randomly selected lenders, such as six different lenders. The server randomly selects the six different lenders from a list of lenders stored within a database. Upon receiving the borrower's loan application, the lenders are allowed to submit a quote (or bid) 82 for certain loan programs. The quote (or bid) is submitted by each lender preferably through an on-line form, which may be accessed by the plurality of lenders, as described above relative to the previous example.

Still referring to FIG. 5, the prospective borrower 74 may then access his or her personal account page within the website by, for example, providing the server (e.g., through an on-line form) with his or her unique username and password. Once the prospective borrower's 74 username and password is validated (confirmed) by the server, the website displays a page in which each lender's quote is shown 84, wherein the quote may also contain information concerning the term, conditions, and contingencies for such quote. The page may also show certain information related to each lender, such as each lender's contact information. At this point, if the prospective borrower 74 has questions regarding a particular quote, the borrower 74 may contact the applicable lender 86. In addition, at this point, the borrower 74 may accept a particular quote from a lender 86. The webpage in which the quotes are displayed will preferably include a button (or other website-mediated form element) that may be selected by the borrower 74 in order to instruct the server that the borrower wishes to accept the quote offered by a particular lender.

If the borrower 74 elects not to accept any quote from any lender, such non-election may be communicated to the server by the borrower 74 through the website (or, alternatively, the server may be programmed to automatically non-select the provided quotes if a certain amount of time elapses without the borrower 74 making a selection). If the borrower 74 elects not to accept any quote from any lender, the server may randomly select another limited group of lenders to which the borrower's 74 loan application will be submitted 88. Referring to FIG. 5, the transmission of the borrower's 74 loan application to another group of lenders creates another round of quote submission by the lenders 88 and an opportunity for the borrower 74 to select a quote or ask questions of the lenders 90. These steps may be repeated once, twice, or more times. In certain embodiments, if the borrower 74 does not select a particular lender during a first or second round of quotes, the borrower's 74 loan application may subsequently be transmitted to a larger group of lenders, such as all lenders that are located within a particular state 92.

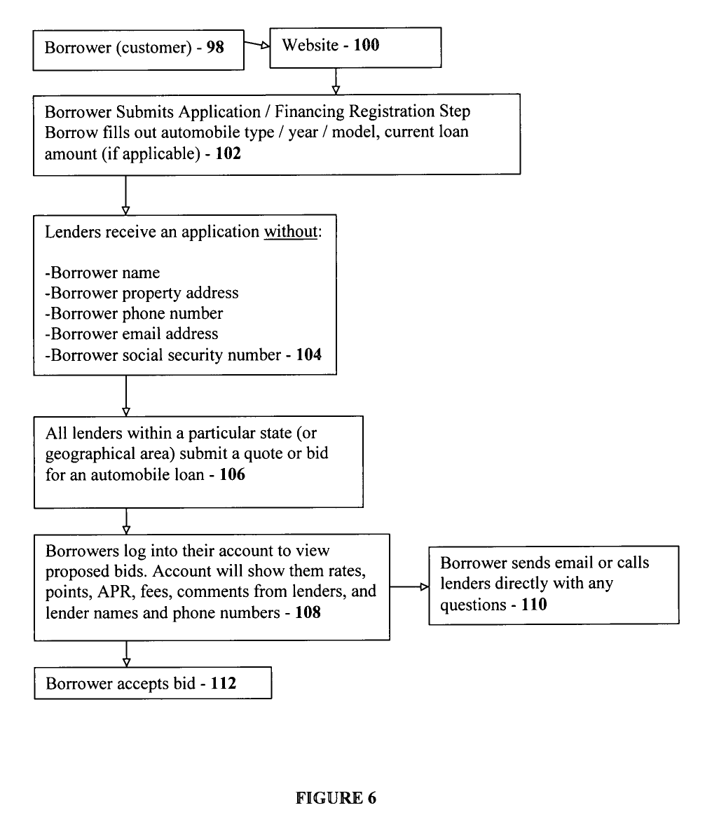

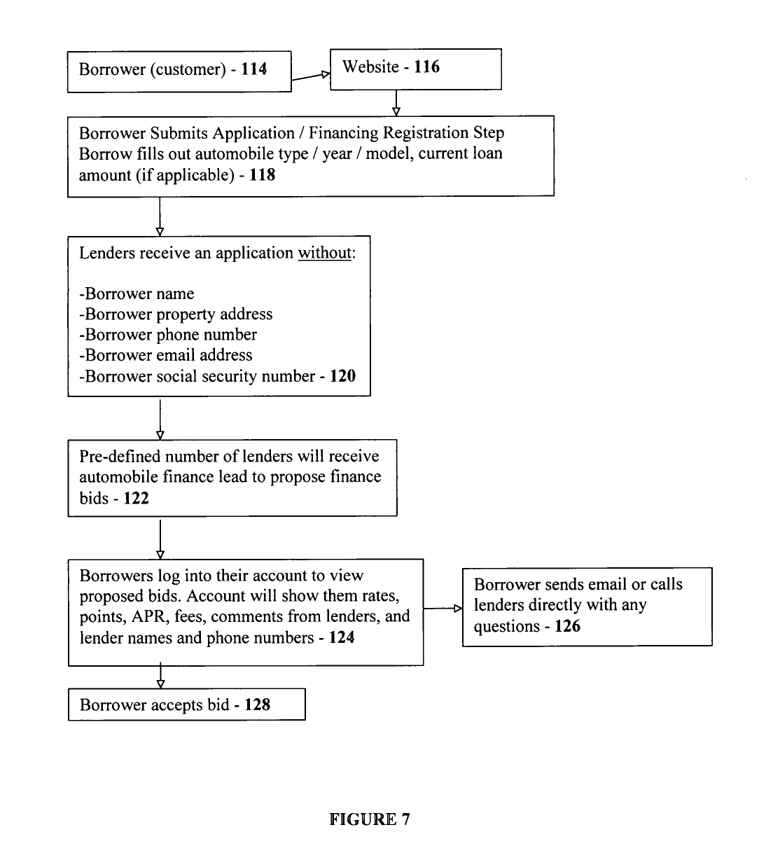

Referring to FIG. 6, the methods of this example may be tailored such that only a single round of quotes are submitted by lenders and considered by a prospective borrower. As shown in FIG. 6, for example, upon submitting a quote 106 in response to a borrower's 98 loan application, the borrower 98 is granted the ability to review the quotes 108, ask questions 110, and, optionally, select a quote 112. However, if the borrower 98 does not select a particular bid (or quote) 112, the borrower 98 must re-submit a new loan application 102 in order to receive an additional set of bids (or quotes). Still further, according the methods of FIG. 7, the borrower's 114 loan application may be submitted to a pre-defined number of lenders 122, whereby the number of lenders to which the application is delivered may be managed by the website operator or specified by the borrower 114.

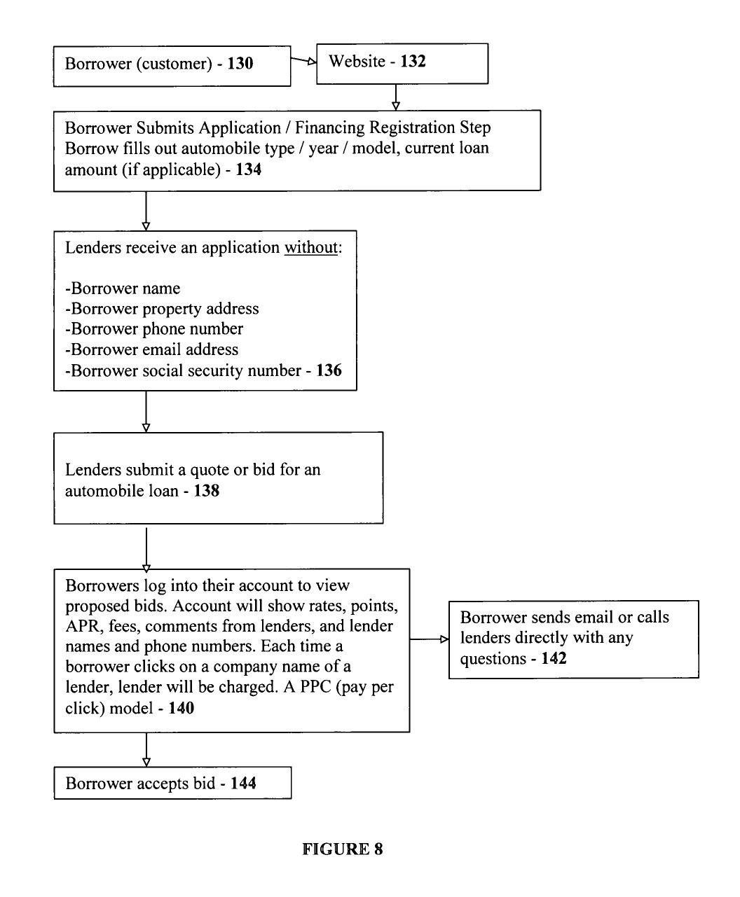

Referring now to FIG. 8, according to additional embodiments of this example, after the borrower 130 submits a loan application through the website 132, and is transmitted to a plurality of lenders, the lenders may submit a quote for the requested loan 138. After the quotes are submitted, the borrower 130 may access the quotes 140, as described herein, in a dedicated webpage. The dedicated webpage, containing such quotes 140, will further include hyperlinks to additional pages which contain additional information related to each particular lender. In such embodiments, the business that owns and operates the website described herein may charge such lender a fee each time a prospective borrower “clicks” on such hyperlink and accesses the lender-specific webpage 140. As with the other embodiments of this example, the borrower 130 may ask questions of a particular lender 142 and/or accept a particular bid (quote) from a lender 144.

While there have been shown and described fundamental features of the invention as applied to preferred embodiments thereof, it will be understood that various omissions and substitutions and changes in the form and details of the methods and systems illustrated and/or described herein, and in their operation, may be made by those of ordinary skill in the art without departing from the spirit of the invention. For example, it is expressly intended that all combinations of those elements and/or method steps which perform substantially the same function in substantially the same way to achieve the same results are within the scope of the invention.

What is claimed is:

1. A method for consummating a loan transaction, which comprises:
(a) providing a website in which a borrower may submit an application for a loan to a plurality of lenders, wherein said application excludes contact and identity information of the borrower; and
(b) providing a server capable of (i) receiving said application and transmitting information contained in said application to a plurality of lenders, (ii) receiving loan bids from the plurality of lenders, and (iii) transmitting and displaying the loan bids to the borrower.

2. The method of claim 1, wherein the loan bids are transmitted and displayed to the borrower within the website.

3. The method of claim 2, wherein the server is further capable of receiving an instruction from the borrower to accept and select a loan bid offered by a single lender.

4. The method of claim 3, wherein the information contained in said application is transmitted to a limited number of lenders.

5. The method of claim 4, wherein the information contained in said application is transmitted to six different lenders.

6. The method of claim 4, wherein if the borrower does not submit an instruction to the server to accept and select a loan bid from any of the limited number of lenders, the information contained in said application is transmitted to a plurality of additional lenders.

7. The method of claim 4, wherein the loan is requested by the borrower to purchase real estate.

8. The method of claim 7, wherein the information contained in said application comprises an amount of financing requested, location of the real estate, and an amount the borrower is willing to pay as an initial installment.

9. The method of claim 4, wherein the loan is requested by the borrower to purchase an automobile.

10. The method of claim 9, wherein the information contained in said application comprises an amount of financing requested, type of the automobile, and an amount the borrower is willing to pay as an initial installment.

11. The method of claim 2, wherein the contact and identity information of the borrower comprises the borrower's name, residential and mailing address, phone number, e-mail address, and social security number.

12. A method for awarding a credit card to a customer, which comprises:
(a) providing a website in which a customer may submit an application for a credit card to a plurality of card issuers, wherein said application excludes contact and identity information of the customer; and
(b) providing a server capable of (i) receiving said application and transmitting information contained in said application to a plurality of card issuers, (ii) receiving bids from the plurality of card issuers, and (iii) transmitting and displaying the bids to the customer.

13. The method of claim 12, wherein the bids are transmitted and displayed to the customer within the website.

14. The method of claim 13, wherein the server is further capable of receiving an instruction from the customer to accept and select a bid offered by a single card issuer.

15. The method of claim 14, wherein the contact and identity information of the customer comprises the customer's name, residential and mailing address, phone number, e-mail address, and social security number.

16. A method for consummating a loan transaction, which comprises:
(a) providing a website in which a borrower may submit an application for a loan to a plurality of lenders, wherein said application includes contact and identity information of the borrower; and
(b) providing a server capable of (i) receiving said application and transmitting information contained in said application to a plurality of lenders, wherein said contact and identity information of the borrower is either redacted or not provided to the lenders, (ii) receiving loan bids from the plurality of lenders, and (iii) transmitting and displaying the loan bids to the borrower.

17. The method of claim 16, wherein the loan bids are transmitted and displayed to the borrower within the website or provided to the borrower via electronic mail.

18. The method of claim 17, wherein the server is further capable of receiving an instruction from the borrower to accept and select a loan bid offered by a single lender.

19. The method of claim 18, wherein upon a borrower selecting a loan bid offered by a single lender, the contact and identity information of the borrower is provided to the single lender.

20. The method of claim 18, wherein if the borrower does not submit an instruction to the server to accept and select a loan bid from any of the plurality of lenders, the information contained in said application is transmitted to a plurality of additional lenders, wherein said contact and identity information of the borrower is either redacted or not provided to the lenders.
